(19) United States
(12) Patent Application Publication
(10) Pub. No.: US 2009/0063617 A1
(43) Pub. Date: Mar. 5, 2009

(54) SYSTEMS, METHODS AND COMPUTER PRODUCTS FOR THROTTLING CLIENT ACCESS TO SERVERS

(75) Inventors: Jeff Calow, Westford, MA (US); Michael T. Cox, Sterling, MA (US); William J. Masek, Bedford, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,053

(22) Filed: Aug. 28, 2007

(51) Int. Cl. G06F 15/16

(52) U.S. Cl. 709/203

(57) ABSTRACT

Systems, methods and computer products for throttling client access to servers. Exemplary embodiments include a method to throttle client access to servers, the method including maintaining local state information on active and pending requests, receiving a delay call from a client, calculating a delay, incrementing a pending operation count, p, returning the delay value to the client, decrementing the pending operation count, p, and incrementing an active operation count, a, in response to a start of an operation by a client, decrementing the active operation count in response to a operation finishing, recording a timestamp to record when a last pending operation should start, and resetting the pending operation count to 0, in response to a next delay request being received after the timestamp is recorded.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to clients and servers, and particularly to systems, methods and computer products for throttling client access to servers.

2. Description of Background

In client/server architectures, some intensive client operations may require significant server resources to execute. If there are multiple clients connected to a server, then a few clients running intensive operations may consume all of the server resources preventing other clients from running operations on the server. There are several current solutions for preventing a few clients from monopolizing server resources. One solution causes operations to fail if the server is loaded, which can make the system seem unreliable, and the server can become overloaded with redundant client retries. Another solution introduces a fixed delay before each client operation. This solution is not scalable as it causes unnecessary delays when the server is not busy and still monopolizes the server when the server is busy, if the operations still come too fast. Another solution includes waiting based of the number of connected clients (e.g., keeping count by keeping open and close session operations, client polling, etc.) or waiting based on server load, types of operations and predicted load. Clients that do not run intensive operations are still penalized. In addition these extra operations associated with maintaining a record of connected clients causes extra load on the server. A further solution simply limits connections to the server, requiring the server to calculate and maintain an accurate count of connected clients. This solution also penalizes clients that are not running intensive operations.

What is needed is an algorithm that introduces a feedback loop so that if the server is running intensive operations, the clients running those operations can back off if the server is busy.

### SUMMARY OF THE INVENTION

Exemplary embodiments include a method to throttle client access to servers, the method including maintaining local state information on active and pending requests, receiving a delay call from a client, calculating a delay for the client, incrementing a pending operation count, p, returning the delay time to the client, when the client starts the operation decrementing the pending operation count, p, and incrementing an active operation count, a, in response to a start of an operation, decrementing the active operation count in response to a operation finishing, recording a timestamp to record when a last pending operation should start, and resetting the pending operation count to 0, in response to a next delay request being received after the timestamp is recorded.

Further exemplary embodiments include a system to throttle client access to servers, the system including a processor coupled to a memory, a process residing in the memory having instructions for maintaining local state information on active and pending requests, receiving a delay call from a client, calculating a delay for the client, incrementing a pending operation count, p, returning the delay time to the client, when the client starts the operation decrementing the pending operation count, p, and incrementing an active operation count, a, in response to a start of an operation, decrementing the active operation count in response to a operation finishing; recording a timestamp to record when a last pending operation should start, and resetting the pending operation count to 0, in response to a next delay request being received after the timestamp is recorded, wherein the delay is calculated by min(0, (a+p)−t)*s, where t is a threshold on a number of active and pending operations to apply the delay, and s is a scaling factor on an overall delay.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which introduces a feedback loop so that if the server is busy running intensive operations, the clients can slow down running intensive operations. As such, if the server is busy running intensive operations then the clients can slow down running intensive operations. Further more clients that are not running intensive operations are not adversely affected by this system.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary system for throttling client access to servers; and

FIG. 2 illustrates a flow chart for a method for throttling client access to servers in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments include systems and methods that introduce a feedback loop so that if the server is busy running intensive operations, the clients can slow down running intensive operations. The exemplary embodiments of the algorithms described herein introduce a feedback loop so that if the server is busy running intensive operations, the clients can slow down running intensive operations. Exemplary embodiments of the algorithms maintain a count of current and pending operations, and then calculate the wait time as a sum of connected and pending operations times with a scaling factor. Scaling allows there to be little or no delay if the server is idle and, as the server gets busier the delays increase. Idle clients that are not active do not impact wait times. In addition, the clients do not load the server by polling, and the server does not need to maintain a list or count of connected clients. The basic algorithm can be generalized for more complex wait algorithms. In exemplary embodiments, any algorithm chosen is kept fast to minimize server load. In exemplary embodiments, the systems and methods described herein can be implemented with a single server used by several clients. In addition, the client can actively change its behavior based on active feedback from the server. As such, with this type of governor, the server can cut down the load from a clients running intensive operations while the server is not yet fully loaded. In this way the server can maintain resources to service high priority requests.

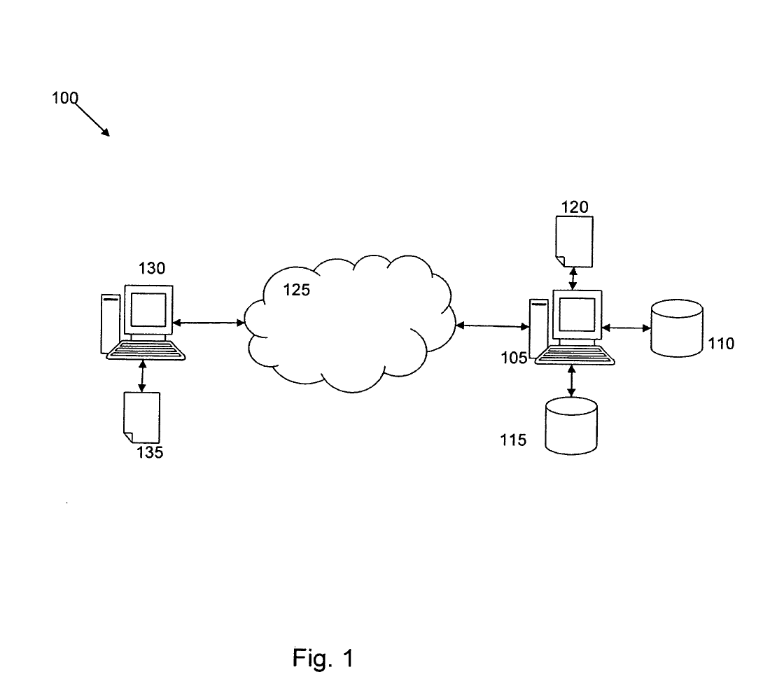

FIG. 1 illustrates an exemplary system 100 for throttling client access to servers. In exemplary embodiments, the system 100 includes a server 105 such as a computer, which includes a storage medium or memory 110. The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the server 105.

A data repository 115 is coupled to and in communication with the server 105. The system 100 can further include process 120 throttling client access to servers, as further discussed herein. The server 105 is further connected to a network 125, such as the Internet. The network 125 can be an IP-based network for communication between the server 105 and any external client 130. The network 125 transmits and receives data between the server 105 and external systems such as the client 130. In exemplary embodiments, network 125 can be a managed IP network administered by a service provider. The network 125 may be implemented in a wireless fashion, e.g., using wireless protocols and technologies, such as WiFi, WiMax, etc. The network 125 can also be a packet-switched network such as a local area network, wide area network, metropolitan area network, Internet network, or other similar type of network environment. The network 125 may be a fixed wireless network, a wireless local area network (LAN), a wireless wide area network (WAN) a personal area network (PAN), a virtual private network (VPN), intranet or other suitable network system and includes equipment for receiving and transmitting signals. The client 130 can include a delay call process 135 as described further herein.

In exemplary embodiments, on the client side (e.g., the client 130) of the system 100, the delay call process 135 can include instructions, such as the following:
waitTime=serverCall.getDelay(operation);
Sleep(waitTime);
Result=serverCall.operation(args);

The above-referenced instructions can prefix current call such as result=serverCall.operation(args), with waitTime=serverCall.getDelay(operation) and sleep(waitTime).

In exemplary embodiments, on the server side of the system 100 (e.g., the server 105), the process 120 can maintain the local state information on active and pending requests. In addition, when a client makes a delay call, the process 120 can calculate the delay and then increment the member of pending operations. When an operation starts, the process 120 can further decrement the pending count and increment the active count. When an operation finishes, the process 120 can decrement the active count. In addition, the process 120 can add a timestamp to record when the last pending operation should start. If the next request for a delay time comes in after the timestamp, then the pending count can reset count to 0 (e.g., if clients disconnect while waiting, the pending count can be reset to 0).

In exemplary embodiments, the delay algorithm can be defined by several parameters, including: a=the number of active operations; p=the number of pending operations; t=the threshold on the number of active and pending operations to apply the delay; and s=the scaling factor on the overall delay, where wait time=min(0, (a+p)−t)*s.

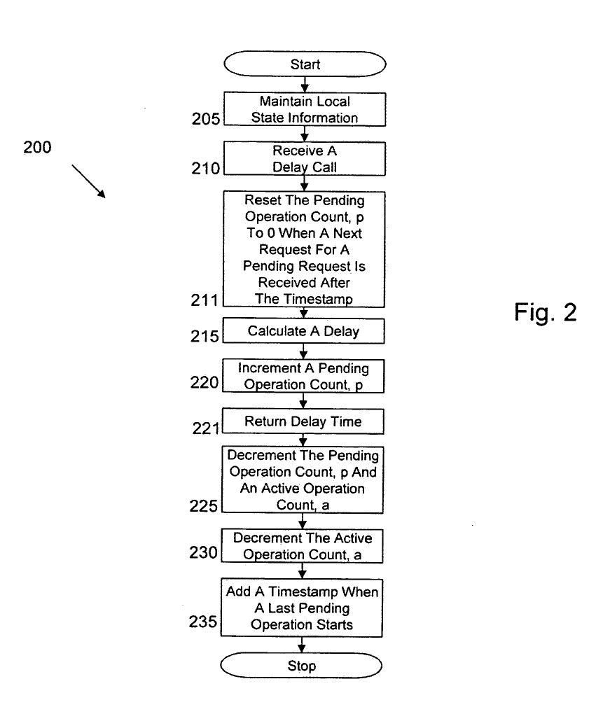

FIG. 2 illustrates a flow chart for a method 200 for throttling client access to servers in accordance with exemplary embodiments. At step 205, the method 200 maintains local state information on active and pending requests on the server 105. At step 210, the server 105 receives a delay call from a client 130, and checks if it should reset the pending operation count at step 211 based on a timestamp updated during step 235. Further, at step 211, the method 200 resets the pending operation count to 0, in response to a next pending request being received after the timestamp is recorded. A delay is calculated at step 215. At step 220, the method 200 increments a pending operation count, p. At step 221 the server returns the delay time to the client and the client is expected to delay the operation by that amount (thus reducing load on the server). At step 225, the client invokes the operation and, as a result of the start of the operation, the method 200 decrements the pending operation count, p, and increments an active operation count, a. At step 230, the method 200 decrements the active operation count in response to an operation finishing. At step 235, the method 200 records a timestamp to record when a last pending operation should be reset and waits for another request to enter at step 210.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method to throttle client access to servers, the method consisting of:
maintaining local state information on active and pending requests;
receiving a delay call from a client;
resetting the pending operation count to 0, in response to a next delay request being received after a timestamp is recorded.
calculating a delay;
incrementing a pending operation count, p;
returning the delay to the client.
receiving the operation call from a client;
decrementing the pending operation count, p, and incrementing an active operation count, a;
decrementing the active operation count in response to an operation finishing; and
recording a timestamp to record when a last pending operation should be reset;

2. The method as claimed in claim 1 further consisting of:
calculating a sum of the pending operation count and the active operation count, (a+p); and
subtracting a threshold, t, on the number of active and pending operations to apply the delay from the sum of the pending operation count and the active operation count, ((a+p)−t).

3. The method as claimed in claim 2 wherein the delay is calculated by multiplying a scaling factor, s, on the delay by the minimum of 0 and ((a+p)−t).

4. The method as claimed in claim 3 wherein the client delay call is given by:
waitTime=serverCall.getDelay(operation);
sleep(waitTime);
result=serverCall.operation(args).

5. A system to throttle client access to servers, the system comprising:
a processor coupled to a memory;
a process residing in the memory having instructions for:
maintaining local state information on active and pending requests;
receiving a delay call from a client;
calculating a delay;
incrementing a pending operation count, p;
returning the delay value to the client.
decrementing the pending operation count, p, and incrementing an active operation count, a, in response to a start of an operation;
decrementing the active operation count in response to an operation finishing;
recording a timestamp to record when a last pending operation should start; and
resetting the pending operation count to 0, in response to a next delay request being received after the timestamp is recorded,
wherein the delay is calculated by min(0, (a+p)−t)*s, where t is a threshold on a number of active and pending operations to apply the delay, and s is a scaling factor on an overall delay.
